(19) United States
(12) Patent Application Publication
(10) Pub. No.: US 2006/0262847 A1
(43) Pub. Date: Nov. 23, 2006

(54) Method of adaptive encoding video signal and apparatus thereof

(75) Inventors: Shu-Yi Chen, Taipei City (TW); Chang-Hung Lee, Dounan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/131,047

(22) Filed: May 17, 2005

(51) Int. Cl. H04N 11/04; H04B 1/66; H04N 11/02; H04N 7/12

(52) U.S. Cl. 375/240.03

(57) ABSTRACT

A method for adaptive encoding a video signal and an apparatus therefor. A predetermined frame resolution and quantizer step size are provided. A first input frame of the video signal is subsequently sampled and encoded based on the predetermined frame resolution and the quantizer step size, respectively. If the size of the encoded first input frame is substantially greater than a first predetermined encoding size, the predetermined frame resolution is reduced and the first input frame is sampled accordingly. The method further includes reducing the predetermined frame resolution if the time period spent in encoding is substantially greater than a predetermined encoding time. The method reduces packet loss or delay during transfer at constant bit rate.

### BACKGROUND OF THE INVENTION

1. Field of the Invention

The invention relates in general to a method of encoding video signal, and more particularly to an method of adaptive encoding video signal and an apparatus thereof.

2. Description of the Related Art

Greater demands for Internet mobility have spurred the development of wireless technologies. FIG. 1 illustrates a conventional wireless network communications system, involving the transfer of data packets over the wireless network from a transmitter Tx end to a receiver Rx end. Generally, input data information, such as an input video, is being encoded by an encoder 110 on the transmitter Tx end before being transferred as data bitstream over the network to the receiver Rx end. A decoder 120 then decodes the encoded video and outputs the video to the corresponding applications.

For continuous transmission of these high-bandwidth multimedia contents, including audio and video, maintaining a network Quality of Service (QoS) is essential for ensuring proper data transfer. QoS is measured in network throughput, packet loss ratio, and packet delay etc.

For wireless transfers, the QoS is limited by, in addition to bandwidth, external interferences, such as multipath interferences. Thus, when the rate of data packets transferring is varying considerably, the resulting packet loss and delay seriously degrade the quality of the output video.

Methods have thus been devised to maintain data transfer at a constant bit rate (CBR) through adjusting quantizer step sizes so as to maintain better video quality. However, adjusting quantizer step size often results in a huge fluctuation in bit rate. Thus, due to the CBR constraint, the allowable range of quantizer step sizes available for adjustments is very limited. Generally speaking, when the input data for instance includes complicated and fast-changing videos, a higher bit rate is thus required to maintain satisfactory video quality. Since the quality of the input video is unknown, to maintain CBR, the conventional approach is to increase the quantizer step size during encoding, which inevitably sacrifices the output video quality. Also, the time required to compress such complicated videos is often very long, thus causing packet loss or delay during transmission. Consequently, the resulting output video appears to be jerky or frozen.

### SUMMARY OF THE INVENTION

It is therefore an object of the invention to provide a method for adaptive encoding a video signal so as to reduce the aforementioned problems.

The invention achieves the above-identified object by providing a method for adaptive encoding a video signal. First, a predetermined frame resolution and a predetermined quantizer step size are provided. Then, a first input frame of the video signal is sampled based on the predetermined frame resolution. The sampled first input frame of the video signal is then encoded based on the predetermined quantizer step size. A step is then performed to determine whether the size of the encoded first input frame is substantially greater than a first predetermined encoding size. If the size of the encoded first input frame is substantially greater than the first predetermined encoding size, then the predetermined frame resolution is reduced and the first input frame is then sampled based on a first reduced frame resolution. Then, the step for encoding is returned to encode the first input frame accordingly. The method further includes checking a time period spent in encoding by comparing with predetermined encoding time. The predetermined frame resolution is reduced and the first input frame is sampled based on a second reduced frame resolution if the time period is substantially greater than the predetermined encoding time.

The invention achieves the above-identified object by also providing an apparatus for encoding a video signal. The apparatus includes a sampler, an encoder, and a calculating unit. The sampler is for sampling a first input frame of the video signal based on a first frame resolution. The encoder encodes the sampled first input frame to generate an encoded first input frame based on a predetermined quantizer step size. The calculating unit determines a size of the encoded first input frame in a predetermined range by adjusting the first frame resolution.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (PRIOR ART) illustrates a conventional wireless network communications system

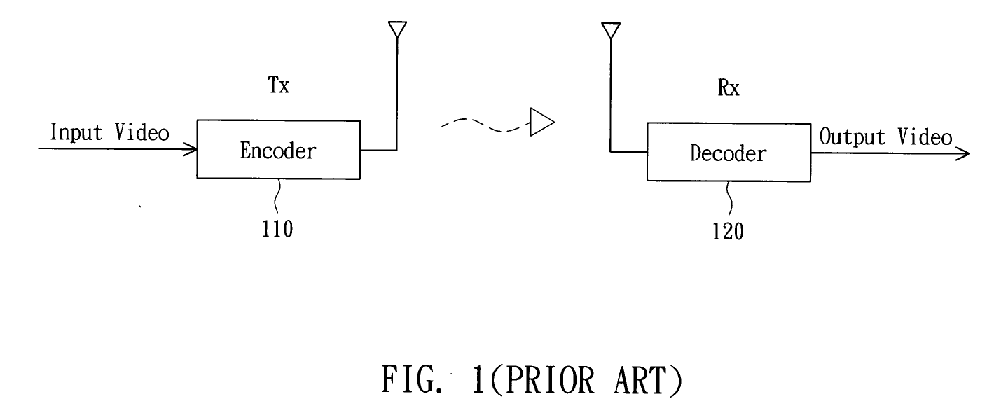

FIG. 2A shows flow diagram of a method for adaptive encoding a video signal according to a preferred embodiment of the invention.

FIG. 2B shows flow diagram of a method for adaptive encoding a video signal according to another embodiment of the invention.

FIG. 2C shows flow diagram of a method for adaptive encoding a video signal according to yet another embodiment of the invention.

FIG. 3 illustrates a method of encoding a second input frame based on the first input frame described in FIGS. 2A, B or C according to a preferred embodiment of the invention.

FIG. 4 shows an apparatus for encoding a video signal according to an embodiment of the invention.

FIG. 5 shows the apparatus 400 applied in a wireless communications system.

### DETAILED DESCRIPTION OF THE INVENTION

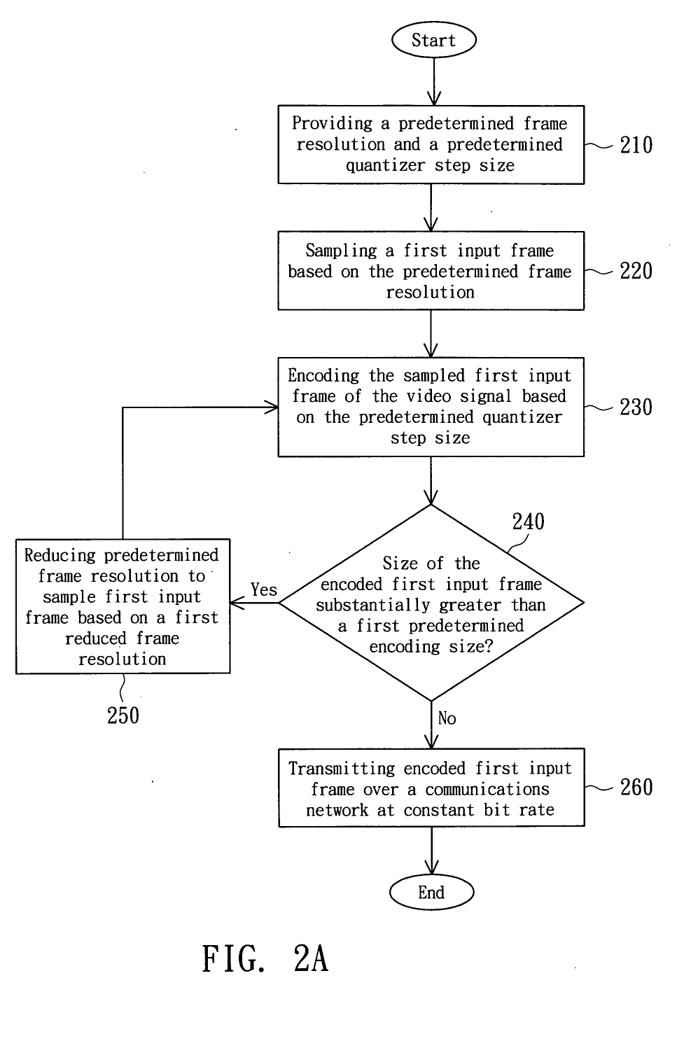

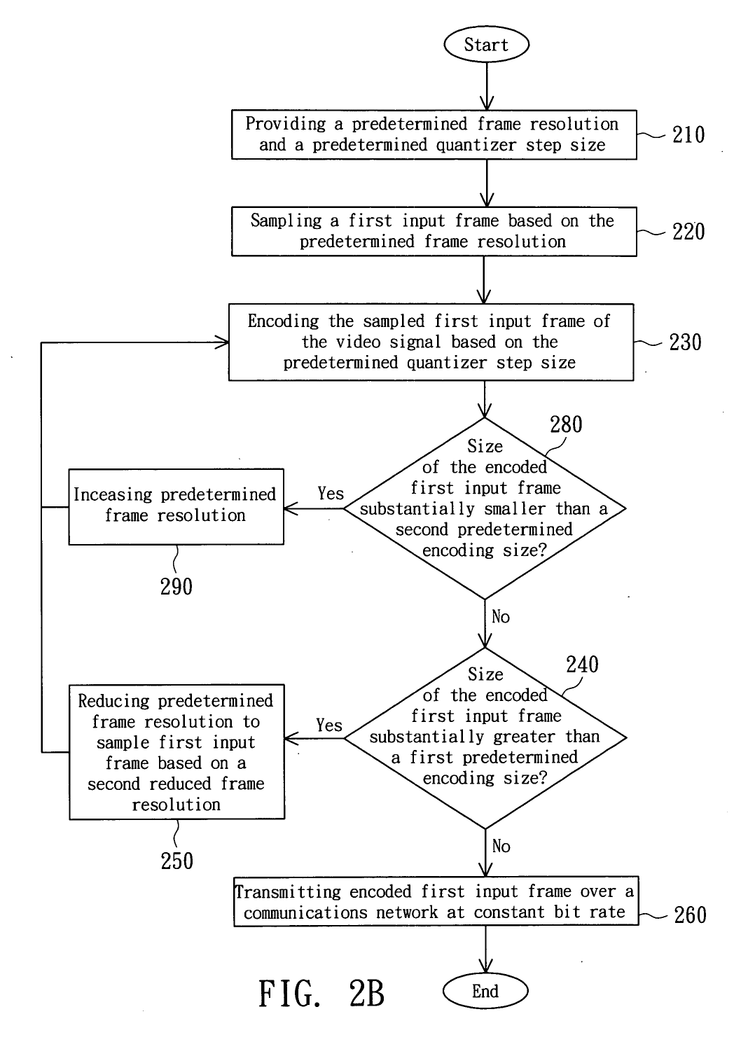

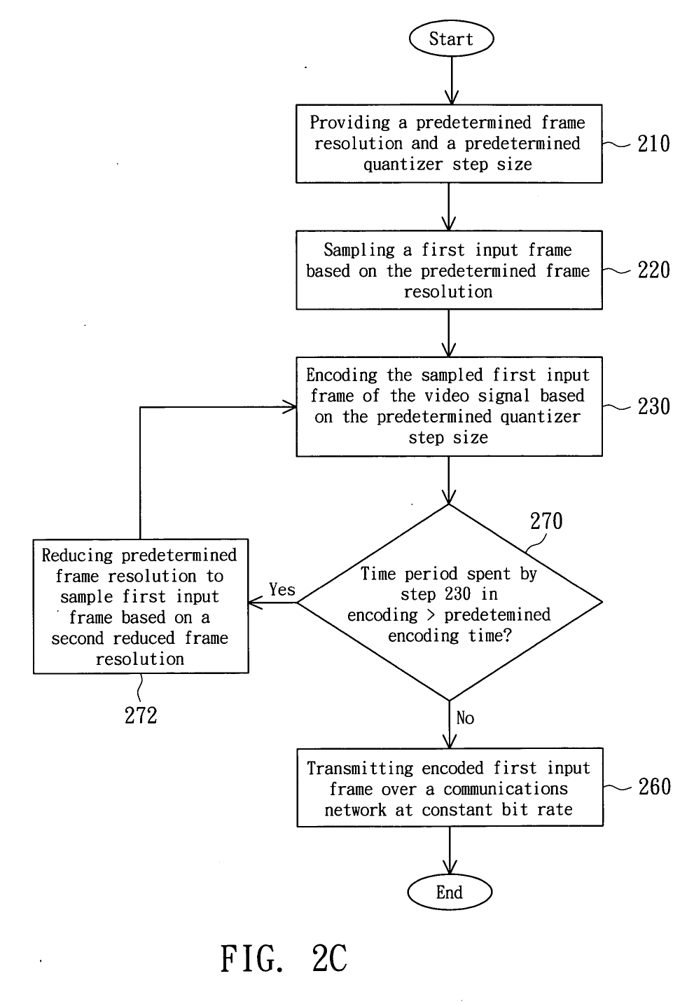

FIG. 2A shows a method for adaptive encoding a video signal according to a preferred embodiment of the invention. Initially, the frame size of the video signal is known. The method thus begins in step 210 in which a predetermined frame resolution and a predetermined quantizer step size are provided. The video signal includes at least a first input frame. Step 220 is performed to sample the first input frame of the video signal based on the predetermined frame resolution of, for instance, 720×480. Thereafter, based on the predetermined quantizer step size, step 230 is performed to encode the sampled first input frame to generate an encoded first input frame. To ensure that the encoding of a complicated frame would satisfy the condition for CBR transfer, step 240 therefore determines whether the size of the encoded first input frame is substantially greater than a first predetermined encoding size. If the size of the encoded first input frame is substantially greater than the first predetermined encoding size, indicative of the encoded first input frame being complicated, then step 250 is performed to reduce the predetermined frame resolution, and the first input frame is sampled based on a first reduced frame resolution and step 230 is returned to encode the first input frame accordingly. Conversely, if the size of the encoded first input frame is not substantially greater than a predetermined encoding size, the encoded first input frame is transmitted over a communications network at a constant bit rate, as shown in step 260, such that for instance the video signal is eventually reconstructed at a receiver end to playback video. Preferably, the communications network is a wireless network. Additionally, the method according to the embodiment of the invention can further determine whether the size of the encoded first input frame is substantially smaller than a second predetermined encoding size, as illustrated in FIG. 2B. FIG. 2B shows a flow diagram of a method for adaptive encoding a video signal according to another embodiment of the invention. As shown in the figure, the added steps 280 and 290, if the size of the encoded first input frame is substantially smaller than a second predetermined encoding size, then the predetermined frame resolution is increased so as to sample the first input frame based on an increased frame resolution, and step 230 is returned to encode the first input frame. By doing so, the overall output video quality is maintained.

As mentioned, due to the constraint in frame rate, i.e. in order to transfer the video signal at CBR, packet loss and jitters are likely to occur when excessive time is taken in encoding the frames of the video signal. Thus, in some embodiments of the invention, a step is devised to check whether a time period spent by the encoder in frame encoding exceeds a predetermined encoding time. FIG. 2C illustrates a method of adaptive encoding a video signal according to yet another embodiment of the invention. The difference between this embodiment and the one illustrated in FIG. 2A is that steps 240 and 250 in FIG. 2A are now replaced by steps 270 and 272. That is, instead of checking whether the size of the encoded first input frame is large enough, step 270 checks if the time period spent by step 230 in encoding is substantially greater than a predetermined encoding time. If yes, then step 272 is performed to reduce the predetermined frame resolution so as to sample the first input frame based on a second reduced frame resolution, and step 230 is then returned to encode the first input frame accordingly. That way, packet delay and packet loss rates can be minimized.

Alternatively, the step 270 from FIG. 2C and the step 240 from FIG. 2A can both be incorporated in a same embodiment of the invention, such that the predetermined frame resolution is reduced if either of the two conditions are true, the two conditions being the size of the encoded first input frame exceeding a first predetermined encoding size, and the time spent by step 230 in encoding exceeding a predetermined encoding time.

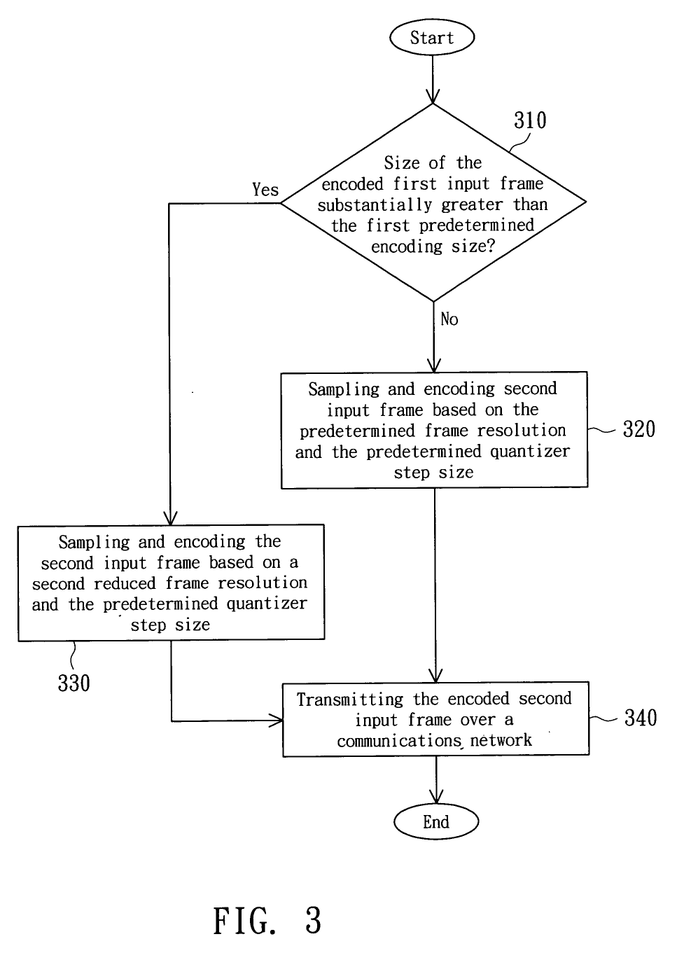

The video signal typically consists of a plurality of frames. To ensure the proper transfer of a series of frames of varying complexity, a method of encoding a successive input frame based on a prior input frame is thus proposed. FIG. 3 illustrates a method of encoding a second input frame based on the first input frame described in FIGS. 2A, B or C according to a preferred embodiment of the invention. The second input frame is sampled and encoded based on the earlier first input frame: if the size of the encoded first input frame is determined to be not substantially greater than the first predetermined encoding size in step 310, then the second input frame of the video signal is being sampled and encoded based on the same predetermined frame resolution and quantizer step size applied on the first input frame, as shown in step 320. If the size of the encoded first input frame is substantially greater than the first predetermined encoding size, then the first input frame is most likely a complicated frame. Thus, it can also be inferred that the second input frame is likely to be complicated. Hence, the frame resolution can for instance be reduced from 720×480 to 360×240 and the second input frame is then sampled and encoded based on the first reduced frame resolution and the predetermined quantizer step size, as shown in step 330, such that the second frame can be properly encoded within the given time slot of the CBR limitation so as to prevent packet delays and jitters. Upon completing in encoding the second input frame in step 320 or step 330, the encoded second input frame is transmitted over the communication network to a receiver, as shown in step 340.

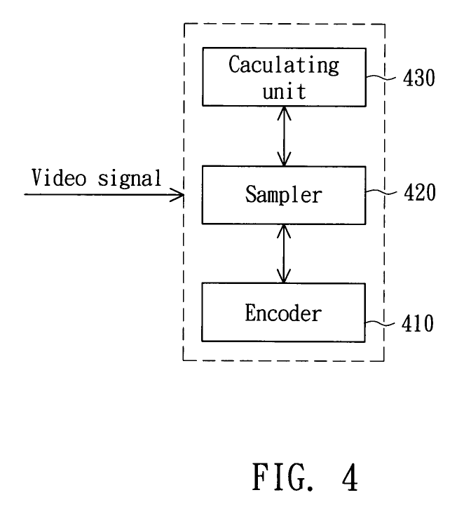

FIG. 4 shows an apparatus for encoding a video signal according to an embodiment of the invention. The apparatus 400 includes a sampler 410, an encoder 420 and a calculating unit 430. The sampler 410 is for sampling a first input frame of the video signal based on a first frame resolution. The encoder 420 encodes the sampled first input frame to generate an encoded first input frame based on a predetermined quantizer step size. The calculating unit 430 determines a size of the encoded first input frame in a predetermined range by adjusting the first frame resolution.

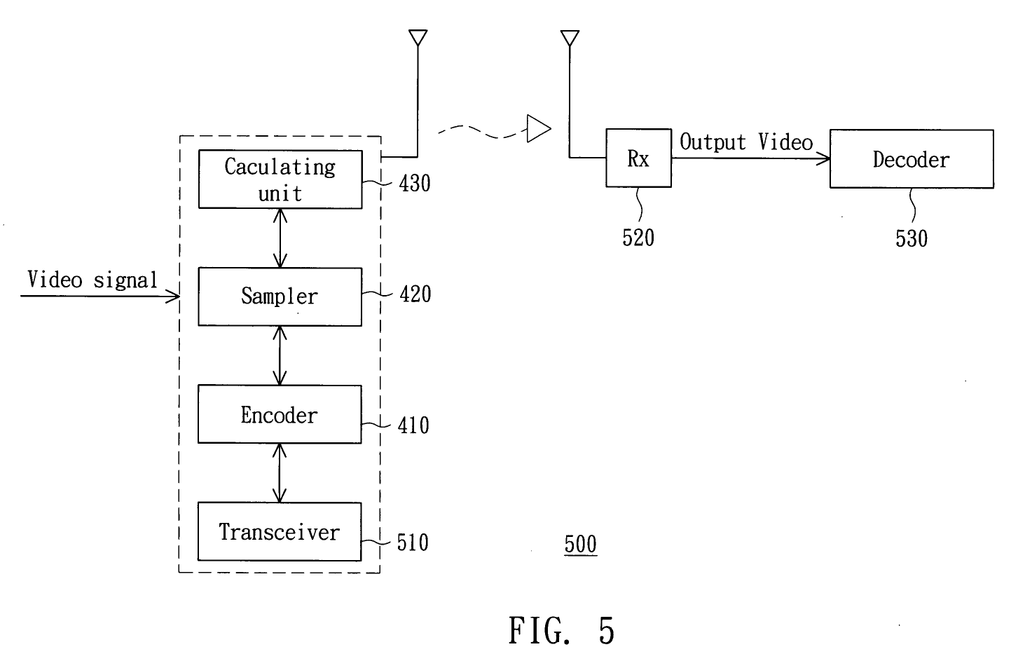

FIG. 5 shows the apparatus 400 applied in a wireless communications system. The apparatus 400 further includes a transceiver 510. The wireless communications system 500 includes the apparatus 400 applied therein, a receiver Rx 520 and a decoder 530. Before transmitting the encoded first input frame, the calculating unit 430 of the apparatus 400 checks if the size of the encoded first input frame is substantially smaller than a second predetermined encoding size. If yes, the calculating unit 430 increases the first frame resolution. The calculating unit 430 of the apparatus 400 further checks if the size of the encoded first input frame is substantially greater than a first predetermined encoding size. If yes, then the calculating unit reduces the first frame resolution. Thus, by adjusting the first frame resolution, the calculating unit 430 is able to determine the size of the encoded first input frame within the predetermined range.

The apparatus 400 adjusts the encoded first input frame until its size is within the predetermined range. Then, the encoded first input frame is transmitted by the transceiver 510 over a communications network at a constant bit rate to the receiver Rx 520. The receiver Rx 520 then outputs the video signal, i.e. the output video, to the decoder 530 to extract the frames of the video signal.

Accordingly, by applying the apparatus and adaptive method for encoding a video signal according the embodiments of the invention, in case when the video signal include a series of complicated and fast changing pictures, the packet delay and jitter resulting from excessive encoding time can be prevented. That is, by appropriately reducing the frame resolution according to the embodiment of the invention, the associated frame size is reduced. Hence, the time required for encoding the frame is also effectively reduced. Thus, the size of the video signal is open up for a greater range of adjustments, and thus satisfies more closely to the limitations in transferring at CBR. Also, as a result of applying the embodiments of the invention, successive frames are more uniform in size, and the output video thus appears to be better in quality when perceived by a user. Also, the smaller sized group of pictures of the video signal requires less time to encode, thus allowing frame rate to be maintained and reducing the problem of the output video appearing jerky and frozen.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for adaptive encoding a video signal, the method comprising:
(a). providing a predetermined frame resolution and a predetermined quantizer step size;
(b). sampling a first input frame of the video signal based on the predetermined frame resolution;
(c). encoding the sampled first input frame of the video signal based on the predetermined quantizer step size;
(d). determining whether the size of the encoded first input frame is substantially greater than a first predetermined encoding size; and
(e). if the size of the encoded first input frame is substantially greater than the first predetermined encoding size, reducing the predetermined frame resolution to sample the first input frame based on a first reduced frame resolution, and returning to step (c).

2. The method according to claim 1 further comprising:
(f). determining whether the size of the encoded first input frame is substantially smaller than a second predetermined encoding size, if yes, increasing the predetermined frame resolution to sample the first input frame based on an increased frame resolution and returning to step (c).

3. The method according to claim 1 further comprising transmitting the encoded first input frame over a communications network at a constant bit rate if the size of the encoded first input frame is not substantially greater than the first predetermined encoding size.

4. The method according to claim 3, wherein the communications network is a wireless network.

5. The method according to claim 1, the method further comprising:
(g). sampling and encoding a second input frame of the video signal based on the predetermined frame resolution and the predetermined quantizer step size if the size of the encoded first input frame is not substantially greater than the first predetermined encoding size; and
(h). sampling and encoding the second input frame based on the first reduced frame resolution and the predetermined quantizer step size if the size of the encoded first input frame is substantially greater than the first predetermined encoding size.

6. The method according to claim 5 further comprising transmitting the encoded second input frame over a communications network.

7. The method according to claim 1, the method further comprising:
(i). checking a time period spent by step (c) in encoding;
(j). if the time period being substantially greater than a predetermined encoding time, reducing the predetermined frame resolution to sample the first input frame based on a second reduced frame resolution and returning to step (c).

8. An apparatus for encoding a video signal, the apparatus comprising:
a sampler for sampling a first input frame of the video signal based on a first frame resolution;
an encoder for encoding the sampled first input frame to generate an encoded first input frame based on a predetermined quantizer step size; and
a calculating unit for determining a size of the encoded first input frame in a predetermined range by adjusting the first frame resolution.

9. The apparatus according to claim 8, wherein the calculating unit increases the first frame resolution if the size of the encoded first input frame is substantially smaller than a second predetermined encoding size.

10. The apparatus according to claim 8, wherein the calculating unit reduces the first frame resolution if the size of the encoded first input frame is substantially greater than a first predetermined encoding size.

11. The apparatus according to claim 8 further comprising a transceiver, for transmitting the encoded first input frame over a communications network at a constant bit rate if the size of the encoded first input frame is not substantially greater than a first predetermined encoding size.

12. The apparatus according to claim 11, wherein the communications network is a wireless network.

13. The apparatus according to claim 8, wherein the calculating unit further samples and encodes a second input frame of the video signal based on the first frame resolution and the predetermined quantizer step size.

14. The apparatus according to claim 8, wherein the calculating unit further checks a time period spent by the encoder in encoding the sampled first input frame, wherein the first frame resolution is reduced if the time period is substantially greater than a predetermined encoding time.
